(19) United States
(12) Patent Application Publication
(10) Pub. No.: US 2013/0201295 A1
(43) Pub. Date: Aug. 8, 2013

(54) STEREO 3D FILMING

(71) Applicant: Michael David Lindsay, London (GB)

(72) Inventor: Michael David Lindsay, London (GB)

(21) Appl. No.: 13/879,455

(22) PCT Filed: Oct. 10, 2011
(86) PCT No.: PCT/GB11/01470

§ 371 Date: Apr. 15, 2013

(30) Foreign Application Priority Data
Oct. 14, 2010 (GB) 1017413.4

(51) Int. Cl. H04N 13/02

(52) U.S. Cl. CPC H04N 13/0282
USPC 348/47

(57) ABSTRACT

A mobile camera rig (1) has a pair of cameras (2, 3) for filming a scene (4) and a chassis (4), which is bodily movable in the Y and Z directions, the X direction being to the scene (4). One camera (2) is mounted on rails (5) and provided with an actuator (6) for altering its position in the Y direction within the rig, that is altering its position laterally of the line of sight to the scene. It receives light from the scene via a beam splitting mirror (8) set at 45° to the line of sight. The other camera (3) is fixed above the mirror and oriented vertically to receive light reflected by the mirror. Movement of the camera (2) within the rig by the actuator changes the apparent inter-axial separation A of the cameras. The rig is provided with an inertial motion sensor (9) and is mounted on apparatus for its bodily movement, including bodily movement of the cameras in the Y and Z direction. The actuator (6) and the motion sensor (9) are connected to a controller (10). The controller is an adjunct to a manual inter-axial separation controller for altering the separation to suit the scene being filmed. The manual controller is not adapted to reduce the separation automatically when the cameras are moved bodily. The controller (10) detects the motion in accordance with the camera movement sensed and causes the separation to be reduced, whilst the cameras are in bodily movement. On cessation of the movement, the separation is restored or rest manually.

The present invention relates to a method of stereo 3D filming.

Typically, stereo 3D photographs and films provide different images to different eyes, stimulating the perception of depth, by the stereopsis effect. Viewing spectacles or glasses are normally required, to provide that the different eyes receive different images. A variety of arrangements are known for this.

Again stereo 3D filming employs two spaced cameras simultaneously photographing the same scene. For far off vistas the cameras may be separated by metres or even tens of metres. For close up scenes, or scenes with great depth, the cameras may need to be so close as to overlap. Such close apparent camera separation can be provided for optically with a mirror system, which separates light into two beams, and pass them into inter-axially spaced cameras. One known mirror system in a known stereo 3D camera rig utilises a single mirror set at 45° to the line of sight to the subject. Ideally half the light passes straight through the mirror to one and half the light is reflected to another. Movement of one or other camera, usually the straight through one, horizontally at right angles to the line of sight alters the apparent inter-axial camera separation.

In this specification, the line of sight to the subject is referred to as the x-axis, lateral real or apparent camera separation is in the y-axis (even although the camera filming the reflected image is oriented in the z-axis).

It is known that bodily movement of the cameras, particularly though not only hand held movement, and particularly translational movement in the y- and z-axes and sometimes in the x- axis as well, at a fixed real or apparent (i.e. mirror, beam split) separation can cause nausea in people viewing films made in this way, at least where the separation is appreciable.

It is conventional for a pair of stereo 3D cameras to be supplied as a unit including the mirror system and for the unit to be bodily mounted on a panning gantry, carriage or other panning apparatus.

The object of the present invention is to provide an improved method of stereo 3D filming

According to a first aspect of the invention there is provided a method of stereo 3D filming with a pair of cameras, means for splitting a light beam from a scene being filmed into split beams to the respective cameras, means modifying the real separation of the cameras or their apparent separation in case of use of means for splitting a light beam from a scene being filmed into split beams to the respective to cameras and means for bodily moving the two camera together, the filming method consisting in the steps of:
filming a scene with an appreciable real or apparent camera separation;
bodily moving the cameras whilst continuing to film; and
reducing the real or apparent camera separation immediately prior to, on or immediately after the beginning of the bodily movement, the filming being continuous through the separation reduction.

My research to date indicates that, for a camera movement that would otherwise cause nausea, the camera separation can be reduced—or reduction initiated —after a delay of around half a second of camera movement that would otherwise cause nausea. On the other hand, I believe that delay beyond one second is liable to contribute to nausea. Nevertheless, experience shows that separation adjustment should be steady and—unless it is masked by movement of the subject being filmed, is preferably carried out over a second's duration or only slightly more.

I anticipate that with great skill, the separation reduction could be made manually. However, I envisage that it will normally be effected via a control system initiated by a motion detection or by a system for controlling the operation of any apparatus which bodily moves the camera. Thus in both these ways, camera separation reduction is linked or derived from camera movement

With the camera separation reduced—normally in practice to an extent achievable only with a mirror system at least in the case of normally professional film cameras—the perceived stereopsis effect is reduced such that the subsequent bodily movement of the cameras does not produce an un-natural and nauseous effect. The camera movement is likely to offer additionally depth cues to the the viewer by way of the motion parallax effect, namely perceived movement of a far object behind a near object. These additional depth cues can often compensate completely for the reduction of depth from reduced stereopsis.

At the end of the bodily movement of the cameras, their separation can be increased again to re-establish the stereo 3D effect due to stereopsis.

According to a second aspect of the invention, there is provided a camera separation controller for control of separation of a pair of cameras mounted in a stereo 3D camera rig, the controller comprising:
means for adjusting their real or apparent separation; and
a controller for controlling their separation in real time whilst filming with the cameras in bodily movement.

It is envisaged that the stereo 3D camera rig may be hand held or it may be mounted on apparatus for bodily moving the cameras.

Normally one at least one of the cameras will be provided with servo control for primary setting of its inter-axial separation with respect to the other; and the controller will be adapted to generate a servo control signal for reduction of inter-axial separation during bodily camera movement and its increase again after such movement. This reduction will over-ride the primary setting which will made by a stereographer assisting the cameraman. The stereographer's setting will be made on his normal control device which acts through the servo control.

Preferably, a bodily camera movement sensor will be provided for providing an input to the controller to cause it to reduce separation on detection of movement.

Alternatively, or additionally, the controller may be adapted to receive a panning apparatus control signal, whereby separation can be controlled in accordance with movement of the panning apparatus.

I also envisage that the controller may be adapted to receive a signal from a switch or the like operated by a cameraman in advance of bodily camera movement, whereby camera separation can be reduced in advance of bodily camera movement. The same effect can be achieved by slightly delaying initiation of bodily camera movement in response to a signal intended to initiate it.

The controller can be adapted to reduce the camera separation by differing amount in accordance with a manual control. This may be a variable control able to to be set from 0% to 100% reduction from the separation before bodily movement.

Alternatively buttons representing for instance 25%, 50%, 75% 100% reduction may be provided. Instead to physical controls their function can be executed in software.

To help understanding of the invention, a specific embodiment thereof will now be described by way of example and with reference to the accompanying drawings, in which:

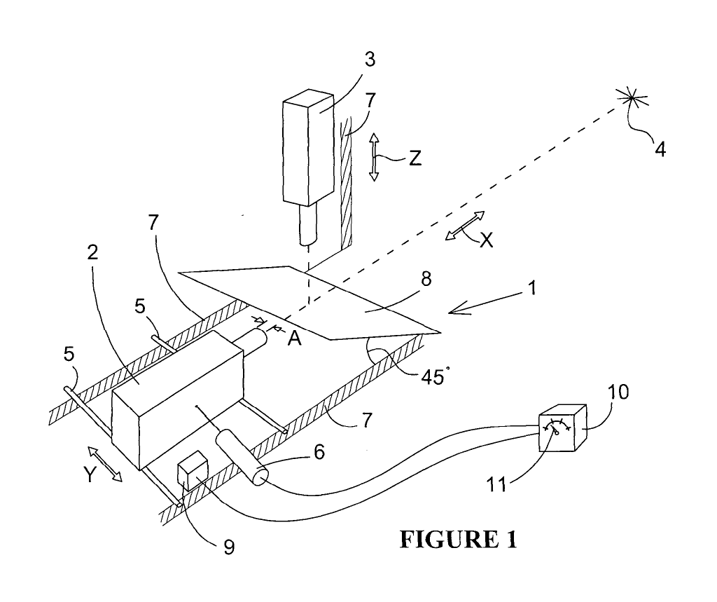

FIG. 1 is a diagrammatic view of a camera separation control system in accordance with the invention.

Referring to FIG. 1, there is a shown a mobile camera rig 1 having a pair of cameras 2,3 filming a scene 4. The rig is shown having a chassis 4, which is bodily movable in the Y and Z directions, the X direction being to the scene 4. One camera 2 is mounted on rails 5 and provided with an actuator 6 for altering its position in the Y direction within the rig, that is altering its position laterally of the line of sight to the scene. It receives light from the scene via a beam splitting mirror 8 set at 45° to the line of sight. The other camera 3 is fixed above the mirror and oriented vertically to receive light reflected by the mirror.

Movement of the camera 2 within the rig by the actuator changes the apparent inter-axial separation A of the cameras.

The rig is provided with an inertial motion sensor 9 and is mounted on apparatus for its bodily movement, including bodily movement of the cameras in the Y and Z direction.

The actuator 6 and the motion sensor 9 are connected to a controller 10. In practice the controller is an adjunct to a manual inter-axial separation controller for altering the separation to suit the scene being filmed. The manual controller is not adapted to reduce the separation automatically when the cameras are moved bodily.

Such movement can cause nausea if the separation is not reduced. The controller 10 detects the motion in accordance with the camera movement sensed and causes the separation to be reduced, whilst the cameras are in bodily movement. On cessation of the movement, the separation is restored or rest manually.

The controller is provided with a preset control 11, whereby for very conventional films the separation can be reduced right down and for films where a feeling of nausea is not amiss, the separation is reduced less.

1. A method of stereo 3D filming with a pair of cameras, means for splitting a light beam from a scene being filmed into split beams to the respective cameras, means modifying the real separation of the cameras or their apparent separation in case of use of means for splitting a light beam from a scene being filmed into split beams to the respective cameras and means for bodily moving the two camera together, the filming method consisting in the steps of:
filming a scene with an appreciable real or apparent camera separation;
bodily moving the cameras whilst continuing to film; and
reducing the real or apparent camera separation immediately prior to, on or immediately after the beginning of the bodily movement, the filming being continuous through the separation reduction.

2. A method as claimed in claim 1, wherein the reduction is initiated within one second of the beginning of the bodily movement.

3. A method as claimed in claim 1, wherein the reduction is initiated within one half second of the beginning of the bodily movement.

4. A method as claimed in claim 1, wherein the reduction is be steady and is carried out over a duration of at least one second.

5. A method as claimed in claim 1, wherein the separation reduction is made manually.

6. A method as claimed in claim 1, wherein the separation reduction is effected via a control system.

7. A method as claimed in claim 6, wherein the control system is connected to a camera bodily movement detector for initiation of the separation reduction.

8. A method as claimed in claim 6, wherein the control system is connected to a system for controlling the operation of apparatus which bodily moves the camera.

9. A method as claimed in claim 1, wherein the separation is increased again to re-establish the stereo 3D effect due to stereopsis at the end of the bodily movement of the cameras.

10. A camera separation controller for control of separation of a pair of cameras mounted in a stereo 3D camera rig, the controller comprising:
means for adjusting their real or apparent separation; and
a controller for controlling their separation in real time whilst filming with the cameras in bodily movement.

11. A camera separation controller claimed in claim 10, wherein:
at least one of the cameras will be provided with servo control for primary setting of its inter-axial separation with respect to the other; and
the controller is adapted to generate a servo control signal for reduction of inter-axial separation during bodily camera movement and its increase again after such movement.

12. A camera separation controller as claimed in claim 11, wherein the controller is adapted for the reduction servo control signal to over-ride a primary stereographic setting made on a control device which acts through the servo control for.

13. A camera separation controller as claimed in claim 10, wherein a bodily camera movement sensor is provided for providing an input to the controller to cause it to reduce separation on detection of movement.

14. A camera separation controller as claimed in claim 10, wherein the controller is adapted to receive a panning apparatus control signal, whereby separation can be controlled in accordance with movement of the panning apparatus.

15. A camera separation controller as claimed in claim 10, wherein the controller is adapted to receive a signal from a switch or the like operable by a cameraman in advance of bodily camera movement, whereby camera separation can be reduced in advance of bodily camera movement.

16. A camera separation controller as claimed in claim 10, wherein the controller is adapted to the controller is adapted to slightly delay initiation of bodily camera movement in response to a signal intended to initiate it.

17. A camera separation controller as claimed in claim 10, wherein the controller is adapted to reduce the camera separation by differing amount in accordance with a manual control being:
a variable control able to be set from 0% to 100% reduction from the separation before bodily movement or
control buttons or software controls representing for instance 25%, 50%, 75%, 100% reduction.

18. A method of stereo 3D filming with a pair of cameras mounted to a rig, said cameras having a real or apparent separation that is adjustable, said method comprising:
filming a scene with an initial real or apparent camera separation with said rig at rest;
initiating movement of said rig whilst continuing to film; and
reducing said real or apparent camera separation within one second of said initiation of movement of said rig, said filming being continuous through said separation reduction.

19. A method as claimed in claim 18, said method further comprising:
stopping said movement of said rig whilst continuing to film; and
increasing said real or apparent camera separation immediately prior to, on or immediately after said stopping of said movement of said rig, said filming being continuous through the separation increase.

20. A method as claimed in claim 19, wherein said increasing step further comprises increasing said real or apparent camera separation to said initial real or apparent camera separation.
